(19) United States
(12) Patent Application Publication
(10) Pub. No.: US 2021/0333055 A1
(43) Pub. Date: Oct. 28, 2021

(54) STRESS RELIEVING ADDITIVELY MANUFACTURED HEAT EXCHANGER FIN DESIGN

(71) Applicant: Hamilton Sundstrand Corporation, Charlotte, NC (US)

(72) Inventors: Paul M. Colson, Westfield, MA (US); Grum T. Ngatu, Manchester, CT (US); John W. Kowalski, Hadley, MA (US)

(21) Appl. No.: 17/212,704

(22) Filed: Mar. 25, 2021

Related U.S. Application Data
(60) Provisional application No. 63/016,680, filed on Apr. 28, 2020.

(51) Int. Cl. F28F 3/04; F28F 3/08

(52) U.S. Cl. CPC F28F 3/048; B33Y 80/00; F28F 3/08

(57) ABSTRACT

A heat exchanger includes a first plate, a second plate separated from the first plate by a gap, and a first fin disposed across the gap, extending between and connected to each of the first and second plates. The first fin includes a stress concentration element disposed at a location separated from a first junction connecting the first fin to the first plate and a second junction connecting the first fin to the second plate.

### CROSS-REFERENCE TO RELATED APPLICATION(S)

This application claims the benefit of U.S. Provisional Application No. 63/016,680 filed Apr. 28, 2020 for “STRESS RELIEVING ADDITIVELY MANUFACTURED HEAT EXCHANGER FIN DESIGN” by A. P. Colson, G. Ngatu, and J. Kowalski.

### BACKGROUND

The present disclosure is directed generally to heat exchangers and, more specifically, to heat exchangers formed via additive manufacturing.

Plate-fin heat exchangers use plates and fins to transfer heat between adjacent flows of fluids. Conventional plate-fin heat exchangers are formed of sheet metal with brazed joints. Stresses tend to be higher at joints between the fin and plate, which can induce cracks and result in failure. The design of plate-fin heat exchangers has been limited by traditional manufacturing methods and by build constraints when produced by additive manufacturing methods, specifically, powder bed fusion. Additively manufactured designs often include fillets at fin corners to reduce stress concentrations. The manufacture of fillets and numerous small features greatly increases CAD and build file size as well as build time, which directly correlates to component cost. Additionally, there are limitations to the minimum thickness of features that can be made with additive manufacturing methods.

### SUMMARY

A heat exchanger includes a first plate, a second plate separated from the first plate by a gap, and a first fin disposed across the gap, extending between and connected to each of the first and second plates. The first fin includes a stress concentration element disposed at a location separated from a first junction connecting the first fin to the first plate and a second junction connecting the first fin to the second plate.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a cross-sectional view of a fin design for a plate-fin heat exchanger of the prior art.

FIG. 2 is an isometric view of a fin design for a plate-fin heat exchanger according to one embodiment of the present disclosure.

FIG. 2A is an enlarged view of a region 2A identified in FIG. 2.

FIG. 3 is an isometric view of a fin design for a plate-fin heat exchanger according to another embodiment of the present disclosure.

FIG. 3A is an enlarged view of a region 3A identified in FIG. 3.

FIG. 4 is an isometric view of a fin design for a plate-fin heat exchanger according to yet another embodiment of the present disclosure.

FIG. 5 is an isometric view of a fin design for a plate-fin heat exchanger according to yet another embodiment of the present disclosure.

FIG. 6 is an isometric view of a fin design for a plate-fin heat exchanger according to yet another embodiment of the present disclosure.

FIG. 6A is an enlarged view of a region 6A identified in FIG. 6.

FIG. 7 is an isometric view of heat exchanger section.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

The present disclosure is directed a fin design for a plate-fin heat exchanger that incorporates additively formed stress concentrations designed to fail and relieve local stresses without causing a leak between interfacing fluids. Prior additively manufactured designs include fillets at fin corners to reduce stress concentrations. The manufacture of fillets greatly increases CAD and build file size as well as build time. Fillets can be eliminated when the disclosed stress concentrations are incorporated into the fin. There is a need for heat exchanger designs that can improve operational life and capability of the component, can reduce weight of the component, and can be efficiently manufactured using additive manufacturing methods.

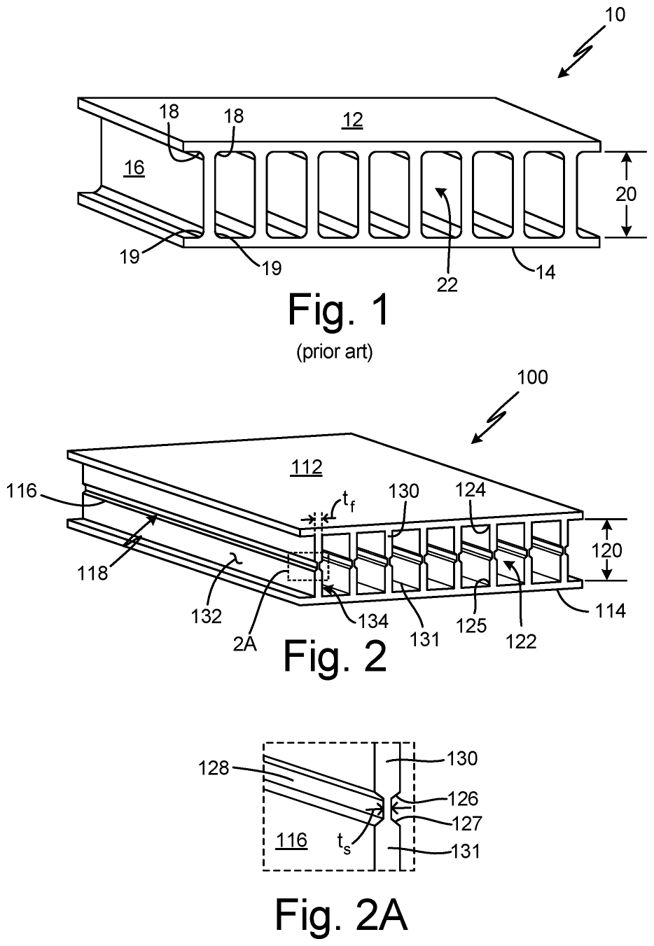

FIG. 1 is a cross-sectional view of a fin design for a plate-fin heat exchanger of the prior art. FIG. 1 shows heat exchanger portion 10, plates 12 and 14, fins 16, fillets 18 and 19, gap 20, and flow channels 22. Plate 12 is separated from plate 14 by gap 20. Fins 16 are disposed across gap 20, extending between and connected to plate 12 at one end and plate 14 at an opposite end. Fins 16 are spaced to form flow channels 22. Fins 16 are joined to plates 12 by fillets 18 located on each side of fin 16 and are joined to plate 14 by fillets 19 located on each side of fin 16. Fillets 18 and 19 reduce stress concentrations at the corner joints connecting fin 16 and plates 12 and 14. Fins 16 have uniform thickness extending between fillets 18 and 19. Fillets 18 and 19 at fin corners reduce stress concentrations in this region. The manufacture of fillets 18 and 19, however, greatly increases CAD and build file size as well as build time.

FIGS. 2-6 illustrate varying fin designs for a plate-fin heat exchanger, which eliminate the need for fillets at the junction between fins and plates. Each of the disclosed fin designs incorporates an additively formed stress concentration designed to fail and relieve local stresses without causing a leak between interfacing fluids. The stress concentration elements are located away from structural walls (i.e., plates) where stresses could cause further crack propagation after failure. Varying patterns of fin thickness, geometry, and stress concentration shaped features are disclosed to control fin stiffness, minimize the probability of cracking, as well as the size, relative location, and quality of cracks so that they occur in areas of low risk (i.e., minimal impact to design service life of the heat exchanger). The stiffness of internal structures can be tuned to minimize maximum stress and to allow for deformation in specific areas that require flexibility due to the applied loads during operation. Fins can be designed to relieve local stresses and to reduce the propagation of cracks after failure. Fins can be designed to fail in such a way that fins do not block flow channels when they fail or fully rupture. The disclosed plate-fin heat exchangers can be made using layer-by-layer additive manufacturing processes, including but not limited to laser powder bed fusion.

FIG. 2 is an isometric view of a fin design for a plate-fin heat exchanger according to one embodiment of the present disclosure. FIG. 2A is an enlarged view of a region 2A identified in FIG. 2. FIGS. 2 and 2A are discussed together. FIG. 2 shows heat exchanger portion 100, plates 112 and 114, fins 116, stress concentration element 118, gap 120, flow channels 122, and junctions 124 and 125. Stress concentration element includes chamfers 126 and 127 and region of reduced fin thickness 128. Fins 116 include sections 130 and 131 and opposite sides 132 and 134. FIG. 2A shows fin 116, including sections 130 and 131, and chamfers 126, 127 and region 128 of stress concentration element 118.

Plates 112 and 114 are separated by gap 120. Fins 116 extend between and connect plates 112 and 114 to form flow channels 122 defined between plates 112 and 114 and adjacent fins 116. Fins 116 are joined to plates 112 and 114 at junctions 124 and 125, respectively. A first section 130 of fins 116 extends between junction 124 and stress concentration element 118. A second section 131 of fins 116 extends between junction 125 and stress concentration element 118. First and second sections 130 and 131 transition to region 128 of reduced thickness via chamfers 126 and 127. During operation, a first fluid flows through channels 122 between plates 112 and 114 and a second fluid flows across outer surfaces of plates 112 and 114 opposite channels 122. Plates 112 and 114 serve as the interface between first and second fluids. Heat is transferred between plates 112 and 114 from one of the first and second fluids to the other of the first and second fluids.

Plate 112 is separated from plate 114 by gap 120. Plate 112 extends parallel to plate 114. Fins 116 are disposed across gap 120, extending between and connected to plate 112 at one end and plate 114 at an opposite end. Fins 116 are disposed transverse to plates 112 and 114. Fins 116 extend a length of plates 112 and 114. Fins 116 are disposed in rows separated by flow channels 122. Adjacent fins 116 are spaced apart to form flow channels 122. The number of fins and spacing distance can be selected based on operational requirements, including static and dynamic loads. In some embodiments, fins 116 can be spaced apart 0.005-3.0 inches (0.127-76.2 millimeters) Fins 116 are joined to plates 112 at junction 124 and are joined to plate 114 at junction 125. Junctions 124 and 125 are free of fillets. Junctions 124 and 125 form right angles between fins 116 and plates 112 and 114. Fin thickness t_{f} remains substantially uniform in first section 130 between junction 124 and stress concentration element 118 and in second section 131 between junction 125 and stress concentration element 118. Fin thickness t_{f} can be selected to accommodate thermal and structural loading. Fin thickness t_{f} can vary from one region of a heat exchanger to another to account for variations in thermal and structural loads. In some embodiments, fin thickness t_{f} can range from 0.001-0.375 inches (0.025-9.53 millimeters).

Stress concentration element 118 is disposed on fin 116 between junctions 124 and 125. Stress concentration element 118 can be centrally located between junctions 124 and 125 or can be positioned closer to either of junctions 124 or 125. The location of stress concentration 118 can be selected to relieve local stresses without causing a leak between interfacing fluids. Stress concentration element 118 is located away from plates 112 and 114 where stresses could cause further crack propagation after failure.

Stress concentration element 118 includes region 128, which is a region of reduced fin thickness. Region 128 can extend parallel to plates 112 and 114 along a full length of fin 116. Fin 116 has thickness tₛ in region 128 of stress concentration element 118 which is less than fin thickness t_{f}. Thickness tₛ in region 128 can be selected based on dynamic operational loads to fail or crack to relieve local stresses before failure occurs at junctions 124 and 125, which could cause a leak between interfacing fluids on opposite sides of plates 112 and 114. In some embodiments, thickness tₛ can be approximately half of fin thickness t_{f}. In some embodiments, the ratio of fin thickness t_{f} to thickness tₛ can range from 1.05-20. The size of reduced thickness tₛ can be selected based on local stresses, overall structural strength and stiffness, and material mechanical properties.

Region 128 can be formed by a recess extending from one or both sides 132, 134 of fins 116. Side 132 of fin 116 is disposed opposite of side 134. As illustrated in FIG. 2, sides 132 and 134 of fin 116 are both recessed in an equal amount to form region 128 of stress concentration element 118. In alternative embodiments, one of sides 132 or 134 can be recessed to form region 128 or sides 132 and 134 can be recessed in unequal amounts such that region 128 is positioned closer to one of sides 132 or 134.

First sections 130 and 131 can join region 128 by chamfers 126 and 127, respectively. Chamfers 126 and 127 provide a linear transition between each of first sections 130 and 131 having thickness t_{f} and region 128 of reduced thickness tₛ. Chamfers 126 and 127 can reduce stress at junctions between fin sections 130, 131 and region 128 and localize stress concentration in region 128. Chamfers 126 and 127 do not have the same processing requirements as fillets and can be incorporated without significantly adding to build file size or build time. Stress concentration element 118 can be disposed over less than 70 percent of a height of fin 116 extending between plates 112 and 114 (i.e., size of gap 120). In some embodiments, a height h of region 128 is less than 50 percent of the height of fin 116. In some embodiments, a height h of region 128 is less than 20 percent of the height of fin 116. In some embodiments, region 128 has a height 0.003-4.5 inches and fins 116 have a height between 0.005-5 inches (0.127-127 millimeters).

Heat exchanger portion 100 can relieve local stresses without causing a leak between interfacing fluids. The fin design of heat exchanger portion 100 concentrates stress away from structural plates 112 and 114 and junctions 124 and 125 where stresses could cause further crack propagation after failure. Any failure caused by dynamic operational loads will occur at stress concentration element 118 and, particularly, at region 128. Cracks that form will have a tendency to propagate along region 128 where fin thickness is reduced thereby limiting risk of damage at junctions 124 and 125, which could result in leaks of interfacing fluids.

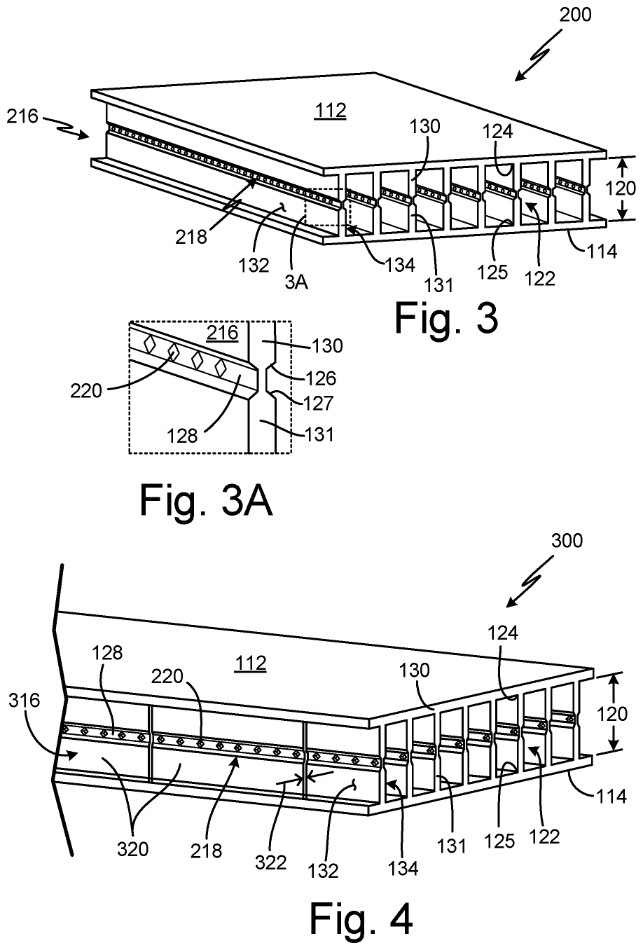

FIG. 3 is an isometric view of a fin design for a plate-fin heat exchanger according to another embodiment of the present disclosure. FIG. 3A is an enlarged view of a region 3A identified in FIG. 3. FIGS. 3 and 3A are discussed together. FIG. 3 shows heat exchanger portion 200. Heat exchanger portion 200 is substantially the same as heat exchanger portion 100 shown in FIG. 2 with a modified stress concentration element 218. FIG. 3 shows plates 112 and 114, fins 116, gap 120, flow channels 122, junctions 124 and 125, sections 130 and 131, and opposite sides 132 and 134. These features are described in the discussion of FIG. 2. FIG. 3 shows stress concentration element 218. Stress concentration element 218 includes chamfers 126 and 127 and region 128 of reduced thickness, as described in the discussion of FIG. 2. Stress concentration element 218 additionally includes apertures 220. FIG. 3A shows fin 216, including sections 130 and 131, and chamfers 126, 127, region 128, and apertures 220 of stress concentration element 118.

Apertures 220 are disposed in region 128 and extend through fins 116 from side 132 to side 134. Apertures 220 can be spaced along a length of region 128 with uniform or non-uniform spacing. Apertures 220 can be aligned in single row running parallel to plates 112 and 114 with region 128. Apertures 220 can be centrally located in region 128 between chamfers 126 and 127. Apertures 220 can be diamond-shaped. In other embodiments, apertures can be any of a variety of shapes including circles, rectangles, and polygons of various arrangements.

Stress concentration element 218 is designed to concentrate stress at apertures 220. The location, size, and geometric shape of apertures 220 can be selected based on dynamic operational loads to fail or initiate cracking to relieve local stresses before failure occurs at junctions 124 and 125, which could cause a leak between interfacing fluids on opposite sides of plates 112 and 114. Additionally, the location, size, and geometric shape of apertures 220 can be selected to arrest crack propagation initiated at adjacent apertures 220. Heat exchanger portion 200 is designed such that any failure caused by dynamic operational loads will occur at stress concentration element 218 and, particularly, at apertures 220. Cracks that form will have a tendency to propagate along region 128 where fin thickness is reduced thereby limiting risk of damage at junctions 124 and 125, which could result in leaks of interfacing fluids. Adjacent apertures 220 can serve as stop holes, which can arrest crack propagation initiated at an adjacent aperture 220.

FIG. 4 is an isometric view of a fin design for a plate-fin heat exchanger according to yet another embodiment of the present disclosure. FIG. 4 shows heat exchanger portion 300. Heat exchanger portion 300 is substantially the same as heat exchanger portion 200 show in FIG. 3 with segmentation of fins 116 along the length of plates 112 and 114. FIG. 4 shows plates 112 and 114, gap 120, flow channels 122, junctions 124 and 125, sections 130 and 131, opposite sides 132 and 134, and stress concentration element 218. These features are described in the discussion of FIGS. 3 and 3A. FIG. 4 additionally shows fins 316, fin segments 320, and gaps 322.

Fins 316 are disposed in rows to form flow channels 122. Each fin 316 is split into fin segments 320 within each row. Fin segments 320 are separated by gaps 322. Fin segments 320 can be separated fully or partially between plates 112 and 114. As illustrated in FIG. 4, gaps 322 extends from plate 112 to plate 114. Gaps 322 can be disposed transverse to plates 112 and 114. Fin segments 320 can be rectangular in shape. Gaps 322 can have a constant width between plates 112 and 114. Gaps 322 can be narrow, having a width that limits fluid flow between rows of fins 316. In some embodiments, fin segments 320 can be separated by a distance (width) of at least 0.002 inches and less than 0.75 inches. The size and orientation of gaps 322 and fin segments 320 can be selected to optimize fluid dynamics within heat exchanger portion 300. In some embodiments, a ratio of fin height (gap size 120) to a width of gap 322 is in a range of 5-200.

As discussed with respect to heat exchanger portion 200, heat exchanger portion 300 is designed such that any failure caused by dynamic operational loads will occur at stress concentration element 218 and, particularly, at apertures 220. Cracks that form will have a tendency to propagate along region 128 where fin thickness is reduced thereby limiting risk of damage at junctions 124 and 125, which could result in leaks of interfacing fluids. Adjacent apertures 220 can serve as stop holes, which can arrest crack propagation initiated at an adjacent aperture 220. Gaps 322 additionally serve to arrest crack propagation along fin 316 and confine crack growth to single fin segments 320.

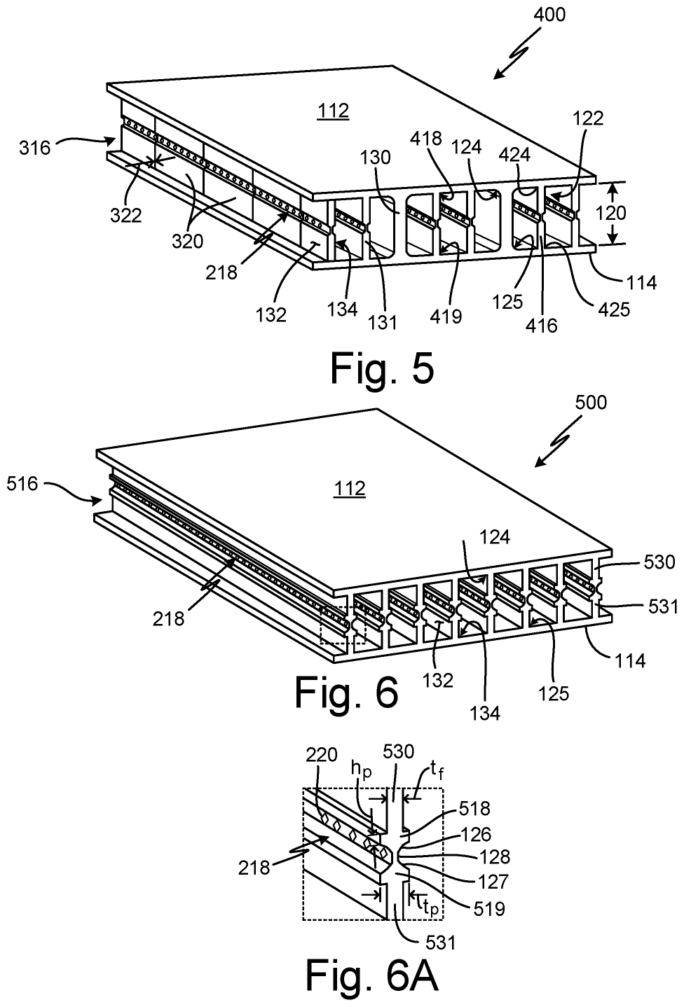

FIG. 5 is an isometric view of a fin design for a plate-fin heat exchanger according to yet another embodiment of the present disclosure. FIG. 5 shows heat exchanger portion 400. Heat exchanger portion 400 is substantially the same as heat exchanger portion 300 show in FIG. 4 with segmentation of fins 116 along the length of plates 112 and 114. FIG. 5 shows plates 112 and 114, gap 120, flow channels 122, junctions 124 and 125, sections 130 and 131, opposite sides 132 and 134, stress concentration element 218, fins 316, fin segments 320, and gap 322. These features are described in the discussion of FIGS. 3, 3A, and 4. FIG. 5 additionally shows fins 416, fillets 418 and 419, and junctions 424 and 425.

Fins 416 are disposed across gap 120, extending between and connected to plate 112 at one end and plate 114 at an opposite end. Fins 416 are disposed transverse to plates 112 and 114. Fins 416 extend parallel to fins 316 along a length of plates 112 and 114. Fins 416 can be disposed between fins 316 to form flow channels 122 there between. Fins 416 can be solid along the length of plates 112 and 114 (e.g., free of gaps 322) such that a single fin 416 extends from a first end of plates 112, 114 to a second end of plates 112, 114. Fins 416 can be load bearing members, having a thickness t_{f} greater than the thickness t_{f} of fins 316 at sections 130, 131. Fins 416 can have a substantially uniform or constant thickness t_{f} between plates 112 and 114. Fins 416 can be joined to plates 112 and 114 by fillets 418 and 419, respectively. Fillets 418, 419 can be located on each side of fins 416. Fillets 418 and 419 form junctions 424 and 425, respectively, where fins 416 meet plates 112 and 114. Fillets 418 extend from one end of fin 416 to plate 112; fillets 419 extend from the opposite end of fin 416 to plate 114. Fins 418 are substantially similar to fins 18 of the prior art as shown in FIG. 1.

Fins 418 provide structural support to heat exchanger portion 400. Fins 416 are joined to plate 112 at junction 424 by fillet 418. Fins 416 are joined to plate 418 at junction 425 by fillet 419. Fillets 418 and 419 reduce the stress concentration at junctions 424 and 425 thereby limiting risk of damage at junctions 424 and 425, which could result in leaks of interfacing fluids. The number of fins 416 and spacing distance can be selected based on operational requirements, including static and dynamic loads. As illustrated in FIG. 5, two fins 416 are separated by two fins 318 with fins 416 positioned in a central region of heat exchanger portion 400. In alternative embodiments, fins 416 can be separated by more or less fins 316 and fins 416 can be positioned in different locations of heat exchanger portion 400. Fin thickness t_{f} can be selected to provide structural support to heat exchanger portion 400. In some embodiments, fin thickness t_{f} can be approximately twice the thickness of fins 318 in sections 130 and 131 (i.e., two times t_{f}). Fin thickness t_{f} can be selected based on structural strength and stiffness required in the heat exchanger. Fins 416 can be sized to avoid rupture of the heat exchanger at a specific pressure or temperature. A high pressure design may require an additional number of fins 416 or may require fins 416 having an increased thickness depending on the goals of the design (e.g., structure versus thermal/fluid performance).

FIG. 6 is an isometric view of a fin design for a plate-fin heat exchanger according to yet another embodiment of the present disclosure. FIG. 6A is an enlarged view of a region 6A identified in FIG. 6. FIGS. 6 and 6A are discussed together. FIG. 6 shows heat exchanger portion 500. Heat exchanger portion 500 is substantially the same as heat exchanger portion 200 show in FIG. 3 with additional crack arresting features. FIG. 6 shows plates 112 and 114, gap 120, flow channels 122, junctions 124 and 125, opposite sides 132 and 134, and stress concentration element 218, including chamfers 126 and 127, reduced thickness region 128, and apertures 220. These features are described in the discussion of FIGS. 3 and 3A. FIG. 6 additionally shows fins 516, projecting elements 518 and 519, and fin sections 530 and 531. FIG. 6A shows fin 516, including sections 530 and 531, projecting elements 518 and 519, and chamfers 126, 127, region 128, and apertures 220 of stress concentration element 218.

Projecting elements 518 and 519 are disposed on either side of stress concentration element 218 between plates 112 and 114. Projecting element 518 is positioned between plate 112 and stress concentration element 218. Projecting element 519 is positioned between plate 114 and stress concentration element 218. Projecting element 518 is joined to section 530 of fins 316. Projecting element 519 is joined to section 531 of fins 316. Projecting elements 518 and 519 can project outward from each of sides 132 and 134 of fins 516 and have a combined thickness tₚ, which is greater than fin thickness t_{f}. The extent to which each projecting element 518 and 519 extends from sides 132 and 134 can vary. The size and shape of projecting elements 518 and 518 can be selected based on the overall design goals, considering material properties, dynamic loading, thermal/fluid performance needs, and height, thickness, and build orientation of fins 516. In one embodiment, projecting element thickness tₚ can be approximately twice the fin thickness t_{f}. Generally, a ratio of projecting element thickness tₚ to fin thickness t_{f} is 1.125-5. A height hₚ of projecting members can also be varied to meet design goals. Generally, a ratio of projecting element height hₚ to fin height 120 is 0.005-0.3. As illustrated in FIGS. 6 and 6A, projecting elements 518 and 519 are centered across fin sections 130 and 131. Projecting elements 518 and 519 can be disposed transverse to sections 130 and 131 and can extend a length of fins 518 parallel to plates 112 and 114. As such, projecting elements 518 and 519 can extend fully along stress concentration element 218. Projecting element 518 can be joined to region 128 of stress concentration element 218 by chamfer 126. Projecting element 519 can be joined to region 128 of stress concentration element 218 by chamfer 127. Chamfers 126 and 127 can extend from outer edges of projecting elements 518 and 519 to region 128 or can extend from a location on projecting elements 518 and 519 between the outer edges and region 128. The size of chamfers 126 and 127 can be selected to reduce stress at the junction between projecting elements 518, 519 and region 128, and localize stress concentration in region 128. Projecting element 518 can be joined to fin sections 530 and 531 by chamfers or corner joints.

Projecting elements 518 and 519 can serve to arrest crack propagation initiated in region 128 of stress concentration element 218 and confine crack propagation to the location of stress concentration element 218. Projecting elements 518 and 519 thereby further limit risk of damage at junctions 124 and 125, which could result in leaks of interfacing fluids.

Heat exchanger portions 100, 200, 300, 400, and 500 can be made via powder bed fusion additive manufacturing processes. Powder bed fusion is an additive manufacturing process in which three-dimensional (3-D) objects are produced from powder in a layer-by-layer fashion directly from a digital model. All powder or selective regions of powder in a powder layer can be fused by melting or sintering with a laser or electron beam as the heat source. CAD and build file size and build time can be reduced by limiting the geometry of a component to that which can be defined by triangular points. As such, the elimination or reduction in number of fillets of the fin disclosed fin designs can reduce CAD and build file size and build time.

Fin designs disclosed in FIGS. 2-6 enhance the ability to build complex heat exchanger designs with existing additive manufacturing process constraints (e.g., CAD and build files size, build time, and minimum feature thickness). Additionally, the disclosed fin designs can be used to reduce a weight of the heat exchanger without compromising the life of the part. For example, the disclosed fin designs allow for manufacture of thinner fins without loss to the structural integrity of fins at fin-plate junctions. The disclosed fin designs limit crack propagation to a region between plates 112 and 114 thereby reducing the potential for leakage of interfacing fluids. The disclosed fin designs can also reduce build time through the elimination or reduction in number of fillets. The disclosed fin designs additionally reduce the risk of fin failure causing channel blockages, which would reduce the performance of the heat exchanger.

Although particular fin design embodiments have been disclosed, it will be understood by one of ordinary skill in the art that any of the features disclosed in FIGS. 2-6 can be combined to produce alternative embodiments. For example, fins 516 in FIG. 6 can be segmented and separated by gaps 322 as shown in FIGS. 4 and 5 to prevent cracks from propagating a full length of fin 516. Projecting elements 518 and 519 can be incorporated into heat exchanger portion 100 of FIG. 2 to help confine crack propagation to stress concentration element 118 and limit crack growth toward plates 112 and 114. Load bearing fins 416, as illustrated in FIG. 5 can be incorporated into any number in any of the embodiments illustrated in FIGS. 2-4 and 6.

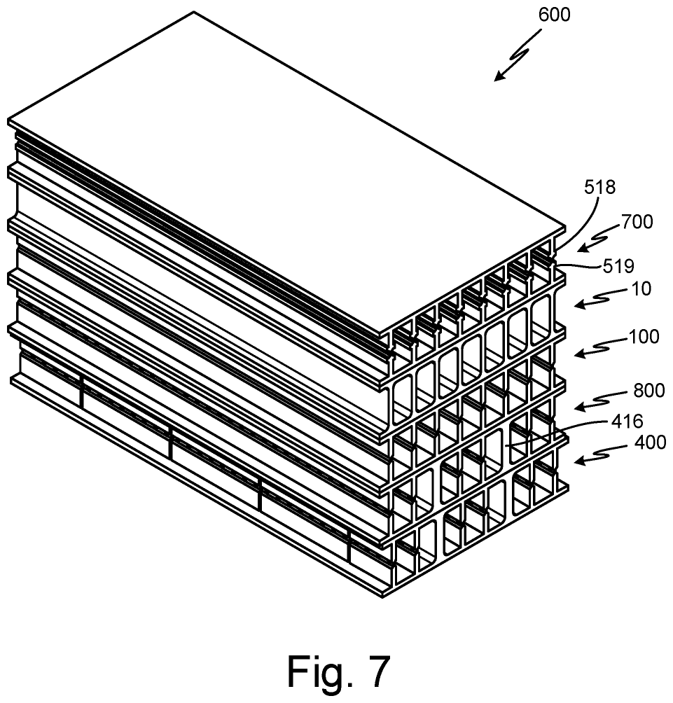

FIG. 7 is an isometric view of heat exchanger section 600. Heat exchanger section 600 includes multiple heat exchanger portions, including 10, 100, 400, 700, and 800 in a stacked arrangement. FIG. 7 is intended to illustrate how fin design can vary from one section of the heat exchanger to another. Heat exchanger sections 10, 100, and 400 were described with respect to FIGS. 1, 2, and 3, respectively. Heat exchanger section 700 is a modification of heat exchanger section 100, which includes projecting members 518 and 519 as described with respect to FIG. 6. Heat exchanger section 800 is a modification of heat exchanger section 200 as described with respect of FIG. 3, including load bearing fins 416 as described with respect to FIG. 5.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

### DISCUSSION OF POSSIBLE EMBODIMENTS

The following are non-exclusive descriptions of possible embodiments of the present invention.

A heat exchanger includes a first plate, a second plate separated from the first plate by a gap, and a first fin disposed across the gap, extending between and connected to each of the first and second plates. The first fin includes a stress concentration element disposed at a location separated from a first junction connecting the first fin to the first plate and a second junction connecting the first fin to the second plate.

The heat exchanger of the preceding paragraph can optionally include, additionally and/or alternatively, any one or more of the following features and/or configurations:

A further embodiment of the foregoing heat exchanger, wherein the stress concentration element comprises a region of reduced first fin thickness.

A further embodiment of any of the foregoing heat exchangers, wherein the stress concentration element is disposed over less than 50 percent of a height of the first fin extending between the first and second plates.

A further embodiment of any of the foregoing heat exchangers, wherein the stress concentration element is centrally located between the first junction and the second junction.

A further embodiment of any of the foregoing heat exchangers, wherein the stress concentration element is offset from a center location between the first junction and the second junction.

A further embodiment of any of the foregoing heat exchangers, wherein the stress concentration element extends parallel to the first and second plates along a length of the first fin.

A further embodiment of any of the foregoing heat exchangers, wherein the stress concentration element includes a plurality of apertures extending through the first fin.

A further embodiment of any of the foregoing heat exchangers, wherein the apertures are spaced along the length of the first fin.

A further embodiment of any of the foregoing heat exchangers, wherein the first fin comprises a first section extending from the first plate to the stress concentration element and a second section extending from the second plate to the stress concentration element, wherein the first and second sections have a first thickness and the stress concentration element has a second thickness less than the first thickness.

A further embodiment of any of the foregoing heat exchangers, wherein each of the first and second sections joins the region of reduced first fin thickness with a chamfer.

A further embodiment of any of the foregoing heat exchangers, wherein the first fin has a first side and a second side disposed opposite the first side and wherein the first side is recessed to form the region of reduced fin thickness.

A further embodiment of any of the foregoing heat exchangers, wherein the second side is recessed to form the region of reduced first fin thickness.

A further embodiment of any of the foregoing heat exchangers, wherein the first fin further comprises a first projecting element and a second projecting element disposed on either side of the stress concentration element, and wherein the first fin has a first thickness at the first and second junctions, a second thickness at the stress concentration element, and a third thickness at the first and second projecting elements, wherein the third thickness is greater than the first thickness and the first thickness is greater than the second thickness.

A further embodiment of any of the foregoing heat exchangers, wherein each of the first and second projecting elements joins the stress concentration element with a chamfer.

A further embodiment of any of the foregoing heat exchangers, and further comprising a plurality of first fins, wherein the first fins are disposed in rows separated by a fluid flow channel and wherein each row comprises a plurality of first fin segments, wherein adjacent first fin segments are separated by a gap, wherein adjacent first fin segments are separated by a distance less than 0.75 inches

A further embodiment of any of the foregoing heat exchangers, and further comprising a second fin extending between and connected to each of the first and second plates, the second fin having a thickness greater than a thickness of the first fin to provide structural support.

A further embodiment of any of the foregoing heat exchangers, and further comprising a plurality of first fins and second fins, wherein second fins of the plurality of second fins are separated by a plurality of first fins.

A further embodiment of any of the foregoing heat exchangers, wherein the second fin is joined to each of the first and second plates by a fillet.

A further embodiment of any of the foregoing heat exchangers, wherein the first fin has a first thickness at locations adjacent the first and second plates and a second thickness at the location of the stress concentration element and wherein the second thickness is less than half of the first thickness.

A further embodiment of any of the foregoing heat exchangers, wherein first and second plates and the first fin are integrally formed and wherein the first and second junctions are formed without fillets.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heat exchanger comprising:
a first plate;
a second plate separated from the first plate by a gap; and
a first fin disposed across the gap, extending between and connected to each of the first and second plates, wherein the first fin comprises a stress concentration element disposed at a location separated from a first junction connecting the first fin to the first plate and a second junction connecting the first fin to the second plate.

2. The heat exchanger of claim 1, wherein the stress concentration element comprises a region of reduced first fin thickness.

3. The heat exchanger of claim 2, wherein the stress concentration element is disposed over less than 50 percent of a height of the first fin extending between the first and second plates.

4. The heat exchanger of claim 2, wherein the stress concentration element is centrally located between the first junction and the second junction.

5. The heat exchanger of claim 2, wherein the stress concentration element is offset from a center location between the first junction and the second junction.

6. The heat exchanger of claim 2, wherein the stress concentration element extends parallel to the first and second plates along a length of the first fin.

7. The heat exchanger of claim 6, wherein the stress concentration element includes a plurality of apertures extending through the first fin.

8. The heat exchanger of claim 7, wherein the apertures are spaced along the length of the first fin.

9. The heat exchanger of claim 7, wherein the first fin comprises a first section extending from the first plate to the stress concentration element and a second section extending from the second plate to the stress concentration element, wherein the first and second sections have a first thickness and the stress concentration element has a second thickness less than the first thickness.

10. The heat exchanger of claim 9, wherein each of the first and second sections joins the region of reduced first fin thickness with a chamfer.

11. The heat exchanger of claim 9, wherein the first fin has a first side and a second side disposed opposite the first side and wherein the first side is recessed to form the region of reduced fin thickness.

12. The heat exchanger of claim 11, wherein the second side is recessed to form the region of reduced first fin thickness.

13. The heat exchanger of claim 2, wherein the first fin further comprises a first projecting element and a second projecting element disposed on either side of the stress concentration element, and wherein the first fin has a first thickness at the first and second junctions, a second thickness at the stress concentration element, and a third thickness at the first and second projecting elements, wherein the third thickness is greater than the first thickness and the first thickness is greater than the second thickness.

14. The heat exchanger of claim 13, wherein each of the first and second projecting elements joins the stress concentration element with a chamfer.

15. The heat exchanger of claim 2, and further comprising a plurality of first fins, wherein the first fins are disposed in rows separated by a fluid flow channel and wherein each row comprises a plurality of first fin segments, wherein adjacent first fin segments are separated by a gap, wherein adjacent first fin segments are separated by a distance less than 0.75 inches.

16. The heat exchanger of claim 2, and further comprising a second fin extending between and connected to each of the first and second plates, the second fin having a thickness greater than a thickness of the first fin to provide structural support.

17. The heat exchanger of claim 16, and further comprising a plurality of first fins and second fins, wherein second fins of the plurality of second fins are separated by a plurality of first fins.

18. The heat exchanger of claim 16, wherein the second fin is joined to each of the first and second plates by a fillet.

19. The heat exchanger of claim 2, wherein the first fin has a first thickness at locations adjacent the first and second plates and a second thickness at the location of the stress concentration element and wherein the second thickness is less than half of the first thickness.

20. The heat exchanger of claim 2, wherein first and second plates and the first fin are integrally formed and wherein the first and second junctions are formed without fillets.
